(19) United States
(12) Patent Application Publication
(10) Pub. No.: US 2007/0029412 A1
(43) Pub. Date: Feb. 8, 2007

(54) Method and apparatus for a vertical spray device

(76) Inventor: Dennis L. Strmiska, Kenedy, TX (US)

Correspondence Address: LAW OFFICES OF CHRISTOPHER L. MAKAY, 1634 Milam Building, 115 East Travis Street, San Antonio, TX, 78205, US

(21) Appl. No.: 11/197,192

(22) Filed: Aug. 4, 2005

(51) Int. Cl. A62C 31/00; B05B 1/32; B05B 1/30

(52) U.S. Cl. 239/569; 239/457; 239/436

(57) ABSTRACT

A spray device includes a valve assembly, in inlet pipe, an extension tube, and a spray tip. The valve assembly includes an inlet, an outlet, and a seal between the inlet and the outlet. A force applied to an actuator pivotably connected to the valve assembly forces the seal away from a sealing position, and allows a pressurized fluid to move from the inlet to the outlet. The fluid exits the outlet, and enters a passage in the extension tube. The spray tip includes a substantially vertical slot that communicates with a passage. The passage of the extension tube further communicates with the passage of the spray tip, thereby forcing the fluid to exit the slot in a wide uniform spray. A second embodiment provides an extension tube including a bend for delivery of the pressurized fluid closer to a ground surface.

### BACKGROUND OF THE INVENTION

1. Field of the Invention

The present invention relates to spraying equipment and, more particularly, but not by way of limitation, to methods and an apparatus for delivering a wide vertical flow of product onto desired foliage.

2. Description of the Related Art

In the areas of pest control, farming, ranching, lawn care, and foliage control, it is often desirable to apply an herbicide, pesticide, liquid fertilizer, or other fluid product onto vegetation for the purpose of either nurturing the foliage, eradicating the foliage, or controlling insects disposed in and around the foliage. While various delivery methods may be utilized, the application of a fluid product onto vegetation is routinely accomplished with a sprayer having a pressurized delivery system, wherein the fluid product is forced through a nozzle to increase a velocity and direct a flow onto the vegetation.

While pressurized delivery systems utilizing nozzles have been in use for some time, problems may arise when fluid stream configurations delivered from the nozzle do not provide effective results. Illustratively, a conventional nozzle delivers a conical spray that is not conducive to spraying large areas requiring multiple passes with a fluid delivery device. In situations where an operator is on foot while treating large areas, the operator walks through the prescribed treatment area, and must attempt to evenly apply fluid delivered from a nozzle. The conical spray pattern of conventional nozzles creates a difficult situation, as the operator is forced to sweep the conical spray pattern back and forth in an attempt to deliver an even distribution of the fluid product onto vegetation. As the operator swings the spraying apparatus up and down, the angle of attack of the nozzle also changes, thereby varying the effective application area of the spraying apparatus. Inconsistent applications may leave spotting, streaks, or pockets of untreated vegetation. Misapplications may require reapplications at later dates, thereby increasing the amount of fluid product required, as well as the direct costs associated with multiple applications of the fluid product.

Accordingly, a spraying apparatus that delivers a substantially vertical uniform elongated spray pattern with an even flow would be beneficial to spraying apparatus operators and those individuals desirous of applying the fluid product to the selected application areas.

### SUMMARY OF THE INVENTION

In accordance with the present invention, a spray device includes a valve assembly, an inlet pipe, an extension tube, and a spray tip that delivers a substantially vertical elongated spray pattern. The valve assembly further includes a first chamber having an inlet, a second chamber having an outlet, and a seal that stops a flow between the passages. The seal is forced from a sealing position when an actuator is depressed. A spring biases the seal to the sealing position, when the force on the actuator is removed.

An inlet of the valve assembly is coupled to a pressurized fluid source. The pressurized fluid source then enters and remains in the first chamber until the actuator is depressed. Upon depression of the actuator, the pressurized fluid moves from the first chamber to the second chamber, and exits the outlet of the second chamber. The pressurized fluid then moves through a passage of an extension tube that is coupled to the outlet. The extension tube further is coupled to the spray tip. The spray tip includes a passage from a first end to a second end. The second end further includes a slot that communicates with the passage. The passage of the extension tube further communicates with the passage of the spray tip, thereby delivering the pressurized fluid to the passage in the spray tip, and out through the slot of the spray tip. The orientation of the slot or the spray tip may be adjusted to provide a substantially vertical delivery, or may be rotated to a predetermined angle. The substantially vertical spray pattern increases the probability of an even application of a fluid to a prescribed treatment area.

In a second embodiment, an extension tube further includes a bend to orient the delivery of the pressurized fluid downward.

It is therefore an object of the present invention to provide a spray device that delivers a wide even distribution of a pressurized fluid.

It is a further object of the present invention to provide a spray tip including a slot for the delivery of a substantially vertical wide even flow.

It is still further an object of the present invention to provide a spray device for delivery close to a ground surface, wherein the extension tube is oriented downward.

Still other objects, features, and advantages of the present invention will become evident to those of ordinary skill in the art in light of the following. Also, it should be understood that the scope of this invention is intended to be broad, and any combination of any subset of the features, elements, or steps described herein is part of the intended scope of the invention.

### BRIEF DESCRIPTION OF THE DRAWINGS

FIG. 1 provides a perspective view of a spray system according to a first embodiment.

FIG. 2 provides a side view of a spray device according to the first embodiment.

FIG. 3 provides an isometric view of the spraying apparatus according to the first embodiment.

FIG. 4a provides a section view of the valve assembly in a closed position according to the first embodiment.

FIG. 4b provides a section view of the valve assembly in an open position according to the first embodiment.

FIG. 5a provides an isometric view of a supply pipe according to the first embodiment.

FIG. 5b provides a section view of the supply pipe according to the first embodiment.

FIG. 6 provides an exploded view of the spraying apparatus according to the first embodiment.

FIG. 7a provides a side view of a spray tip according to the first embodiment.

FIG. 7b provides a front view of the spray tip according to the first embodiment.

FIG. 8a provide a side view of a spray pattern from the spray tip according to the first embodiment.

FIG. 8b provides a top view of a spray pattern from the spray tip according to the first embodiment.

FIG. 8c provide a method flowchart illustrating use of the spray device according to the first embodiment.

FIG. 9 provides a planar view of a second embodiment having a curved wand extension.

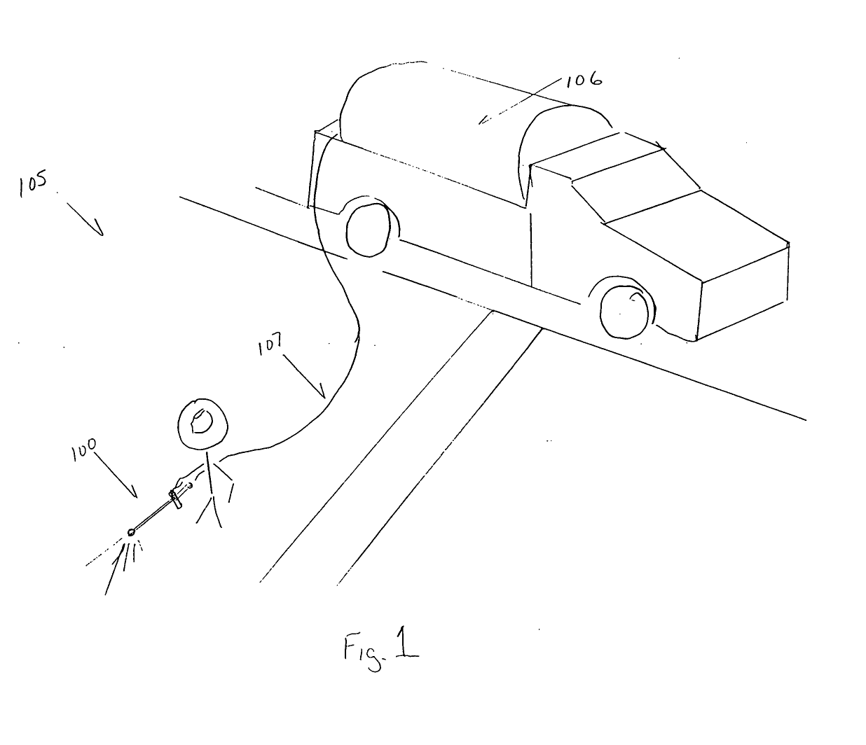

### DETAILED DESCRIPTION OF THE PREFERRED EMBODIMENT

As required, detailed embodiments of the present invention are disclosed herein; however, it is to be understood that the disclosed embodiments are merely exemplary of the invention, which may be embodied in various forms. It is further to be understood that the figures are not necessarily to scale, and some features may be exaggerated to show details of particular components or steps.

A spray system 105 includes a spray device 100 coupled to a product source 106. In this first embodiment, the spray device 100 includes a spray tip 115 that delivers a substantially vertical spray pattern. The spray device 100 may be carried and utilized by an operator as the operator walks to deliver a product from the product source 106. The product source 106 may be any type of product containment system, including large tanks, portable tanks, gallon jugs, or other container that may be pressurized to deliver a fluid product to the spray device 100. The product source 106 may further be mounted onto a service vehicle for portability. The product source 106 may deliver the product to the spray device 100 with a hose 107 capable of withstanding the pressurized fluid. In an alternative embodiment, the product source 106 may be a portable tank that is connectable to the spray device 100, and may be carried by the operator for limited application areas.

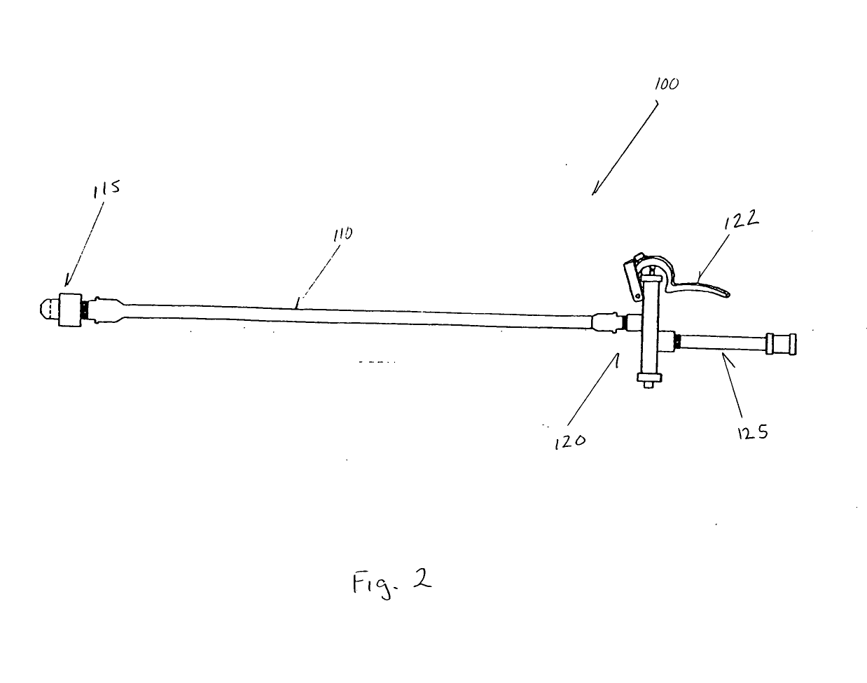

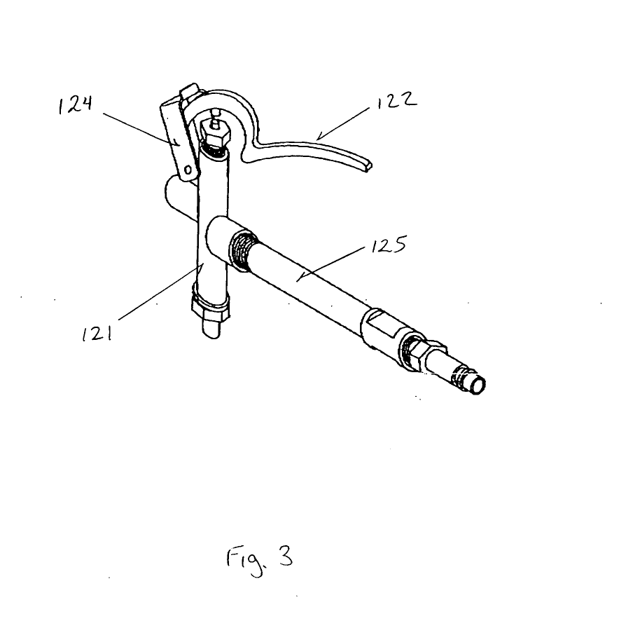

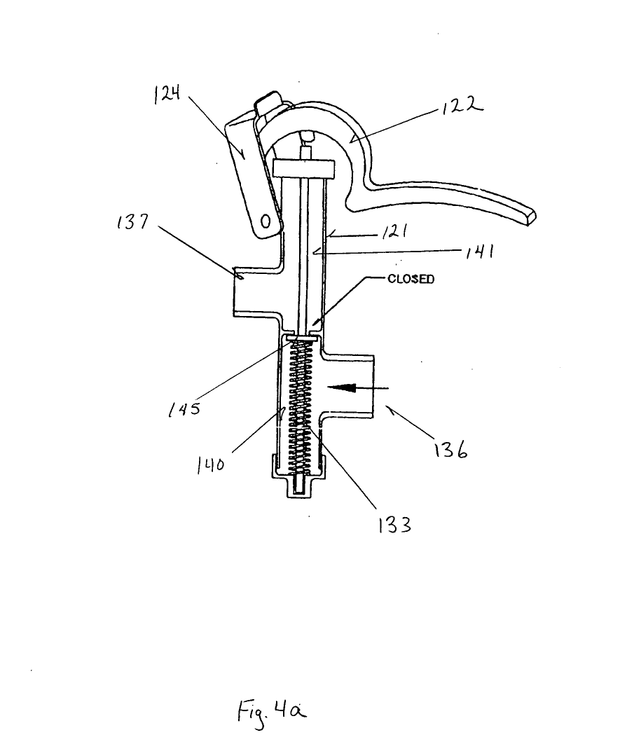

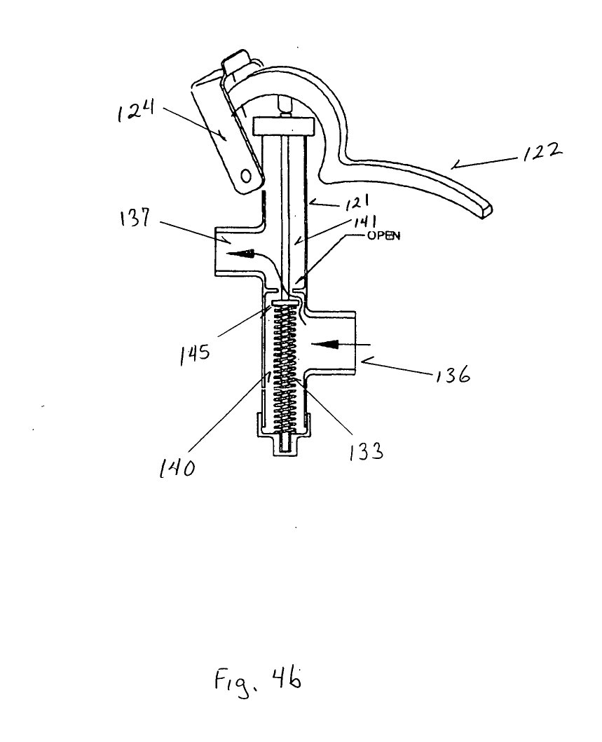

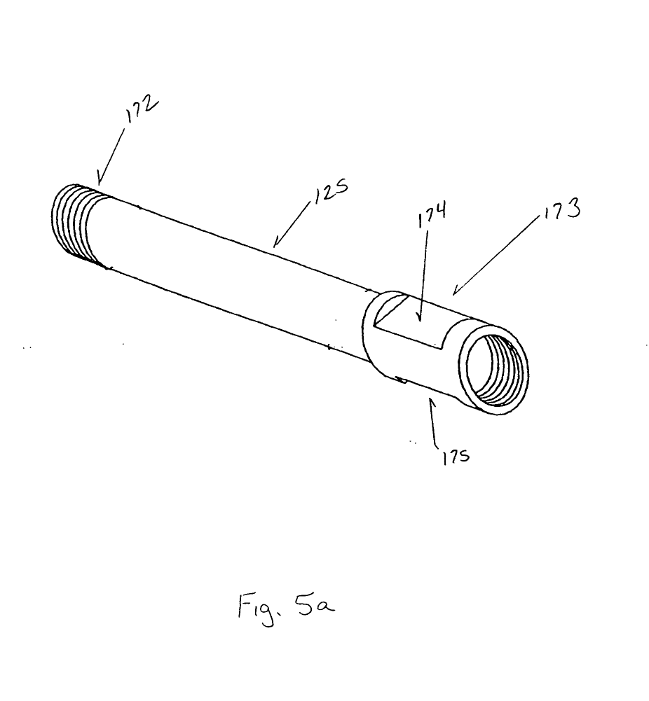

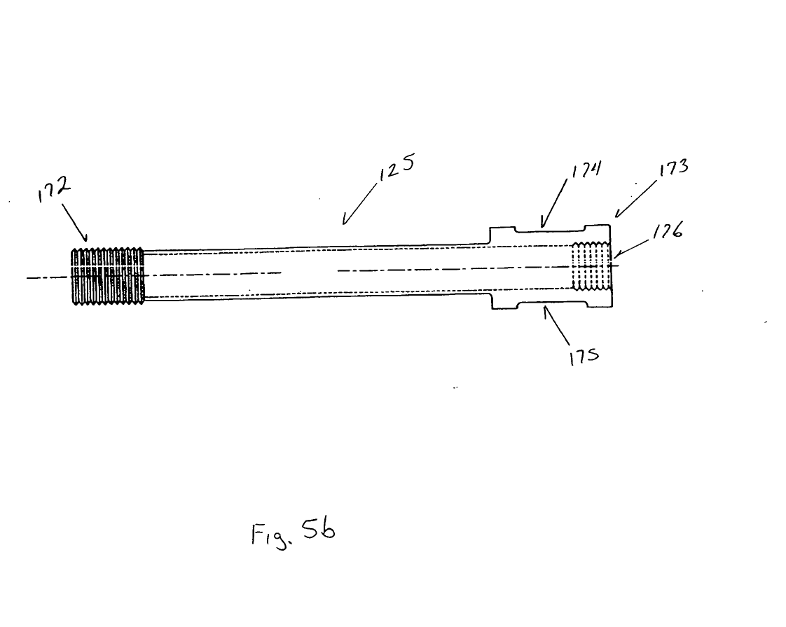

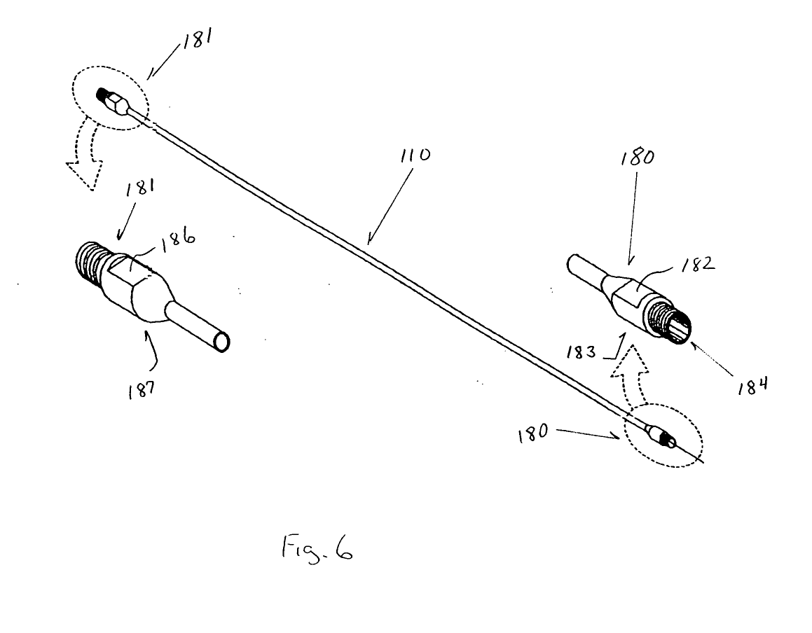

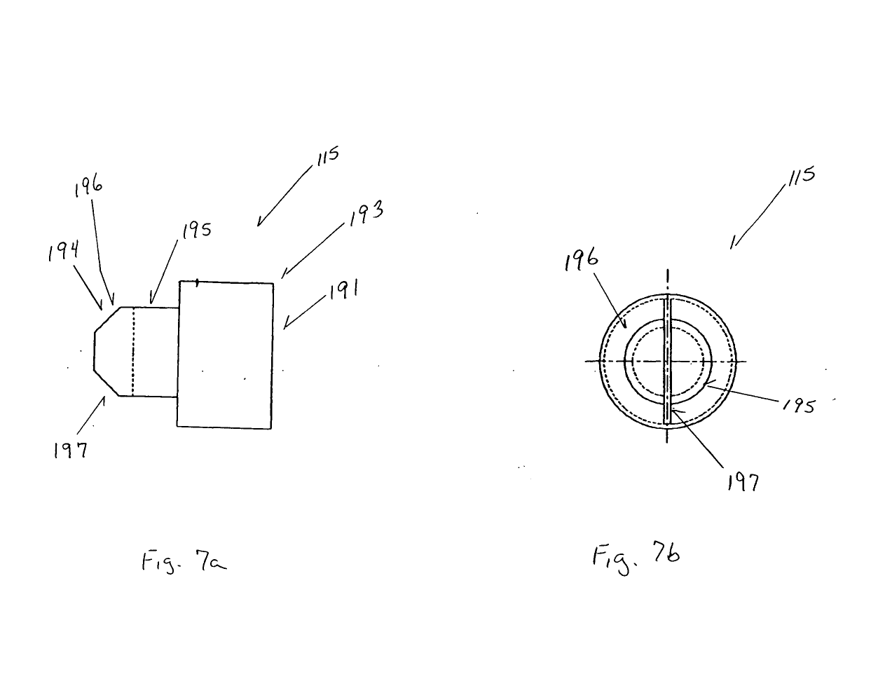

As shown in FIGS. 2-7a, the spray device 100 includes a valve assembly 120, an extension tube 110, and the spray tip 115. The valve assembly 120 includes a body 121 having a first chamber 140 and a second chamber 141. The first chamber 140 includes an inlet 136, and the second chamber 141 includes an outlet 137. The valve assembly 120 may further include an inlet pipe 125 coupled to the inlet 136. The inlet pipe 125 is further in communication with the product source 106 for delivery of the product from the product source 106, through the inlet 136, and into the first chamber 140. The valve assembly 120 further includes an actuator 122 rotatably connected to the body 121. The actuator 122 is preferably extends in a same general direction as the inlet 136. The valve assembly 120 further includes a seal 145 that is displaced from a sealing position when the actuator 122 is depressed. The valve assembly 120 may further include a spring 133 that biases the seal to a closed position, such that the product may only be delivered when the actuator 122 is depressed. The valve assembly 120 may further include a locking mechanism 124.

The inlet pipe 125 is cylindrical in shape, and includes a first end 172 and a second end 173. The second end 173 includes a section of an increased diameter to incorporate a first engagement face 174 and a second engagement face 175. The engagement faces 174 and 175 provide mating point for tools. The inlet pipe 125 further includes a passage 176 passing from the first end 172 to the second end 173. In this embodiment, the first end 172 includes external threads for mating with other components. The second end 173 includes internal threads in the passage 176. The inlet pipe may be formed of any material suitable for contact with chemicals, fertilizers, and the like. For example, the inlet pipe 125 may be constructed from stainless steel, steel, aluminum, or plastics.

The extension tube 110 includes a first end 180 and a second end 181, and a passage from the first end 180 to the second end 181. The first end 180 and the second end 181 are of an increased cross section to provide tooling interface points. Illustratively, the first end 180 includes a first engagement face 182 and a second engagement face 183. The first end 180 further includes external threads that are complementary to the threads of the outlet 137 of the body 121. The second end 181 includes a first engagement face 186 and a second engagement face 187. The second end 181 further includes external threads. The extension tube 110 may be constructed from virtually any material suitable for contact with chemicals, fertilizers, or pesticides. Illustratively, the extension tube 110 may be constructed from stainless steels, aluminum, or brass. The length of this extension tube 110 may vary for a particular use. For example, an extension tube 110 may be long enough to ensure that the sprayed fluid is far enough away from the operator, thereby minimizing the chances of errant inhalation and contact. Typically, the length of the extension tube 110 is in the range of eighteen to twenty four inches. While this extension has been disclosed within the range of eighteen to twenty four inches in length, one of ordinary skill in the art will recognize that virtually any length may be utilized in the spraying device 100.

As shown in FIGS. 7a and 7b, the spray tip 115 includes a first end 193 and a second end 194, and a passage 191 leading from the first end 193 to the second end 194. The first end 193 further includes internal threads in the passage 191 for mating with other components. The second end 194 is of a reduced cylindrical section 195, and includes a taper 196, such that the second end 194 is of a reduced diameter. The second end 194 further includes a slot 197 passing through an axis of the cylindrical section 195, to a depth beyond the taper 196. The slot 197 breaks through the wall of the spray tip 115 to gain entrance to the passage 191. Accordingly, a fluid may enter the passage 191 at the first end 193, move through the passage 191, and exit the spray tip 115 through the slot 197.

The spray device 100 may further include a coupler 126 for mating with a fluid delivery system. The coupler 126 may be any form of connection device, including quick disconnects, threads, unions, or the like. In this embodiment, the coupler 126 is a quick disconnect fitting suitable for use with fluids. In other cases, the spraying device 100 may be permanently secured to a fluid delivery system, and only removed for service.

Assembly of the spray device 100 commences with the first end 172 of the inlet pipe 125 being attached to the inlet 136 of the valve body 121. In this embodiment, the external threads of the first end 172 engage the internal threads of the inlet 136. The first end 180 of the extension tube 110 may then be mounted to the outlet 137 of the body 121, such that the external threads of the first end 180 engage the internal threads of the outlet 137. The spray tip 115 may then be attached to the second end 181 of the extension tube 110. In this embodiment, the internal threads of the passage 191 engage the external threads of the second end 181 of the extension tube 110. The spray tip 115 may then be rotated to align the slot 197 to a vertical orientation, or substantially parallel to the body 121 of the valve assembly 120. The coupler 126 may then be secured to the second end 173 of the inlet pipe 124. All thread joints may require the use of a suitable thread sealer to hold pressure.

Once attached, the passage 176 of the inlet pipe 125 communicates with the first chamber 140, and the passage 184 of the extension tube 110 communicates with the second chamber 141. The passage 184 of the extension tube 110 further communicates with the passage 191 of the spray tip 115.

In operation, a pressurized fluid is delivered from the product source 106 to the inlet 136 of the spray device 100. The pressurized fluid fills the inlet pipe 125 and the first chamber 140. As the seal 145 is biased in a sealing position, the pressurized fluid in the first chamber 140 does not pass the seal 145. The spray device 100 is configured to allow an operator to hold the spray device 100 in one hand, preferably around the inlet pipe 125 and the actuator 122. When the operator moves the actuator 122 towards the inlet pipe 125, the seal 145 moves away from the sealing position, and the pressurized fluid passes from the first chamber 140 to the second chamber 141. The pressurized fluid fills the second chamber 141, and moves through the outlet 137 to the passage 184 of the extension tube 110. The pressurized fluid moves through the passage 184 of the extension tube 110 to the passage 191 of the spray tip 115, and then exits the spray device 100 through the slot 197. The pressurized fluid is delivered in a wide vertical spray pattern, thereby increasing a coverage band.

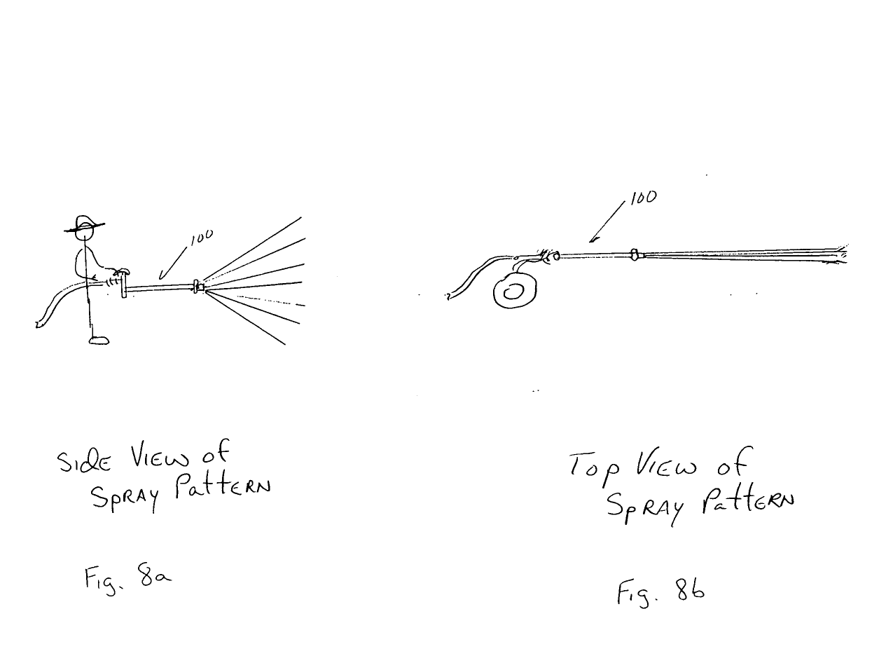

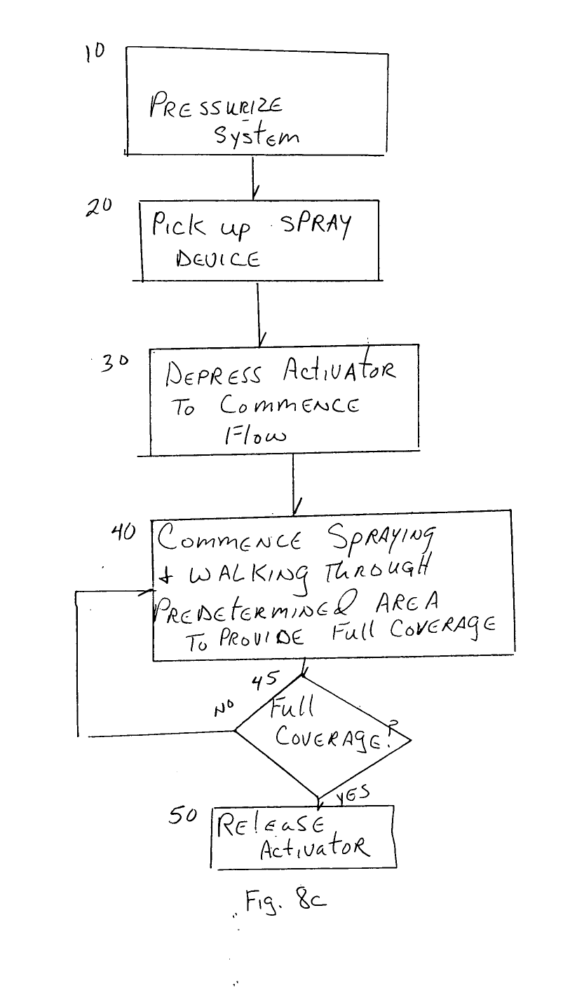

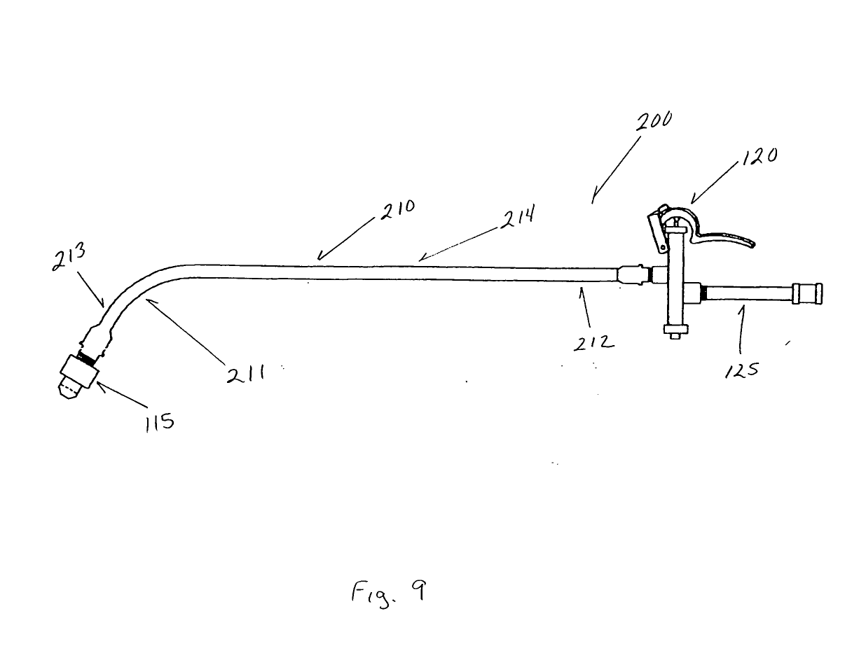

As shown in FIGS. 8a and 8b, the spray device 100 including a spray tip 115 having a slot 197 delivers a wide and narrow flow pattern. FIG. 8a provides a side view of a spray device 100 with a spray tip 115 spraying a product out of the slot 197. The spray tip 115 including the slot 197 delivers a wide substantially vertical spray pattern when viewed from a direction perpendicular to the extension tube 110, and in the same horizontal plane as the extension tube 110. When the spray pattern is viewed from above, the pattern is narrow, as shown in FIG. 8b. The wide substantially vertical pattern provides an even, broad band of product coverage. In cases where the operator must make multiple passes, the spray band width provides sufficient overlap, thereby increasing the chances for full coverage. Additionally, the operator experiences a thrust force when the spray device 100 is delivering a fluid product. The slot 197 of the spray tip 115 is sized to deliver a thrust force sufficient to counteract the weight of the spray device 100, such that the operator is not forced to bear the weight of the spray device 100 for extended periods.

When the operator has completed spraying, the operator releases the actuator 122, thereby allowing the spring 133 to force the seal 145 to return to the sealing position. In the sealing position, the flow of the pressurized fluid is halted, and the pressurized fluid remains within the first chamber 140.

In cases where the operator desires a continuous spray, the operator may slide the lock 124 over the actuator 122 when the actuator 122 is depressed, and stop the rotation of the lock 124 at varying points along the actuator 122. The actuator 122 is then restricted from rising due to the containment by the lock 124. In the locked position, the spray device 100 delivers pressurized fluid continuously. When the operator is through spraying, the operator may rotate the lock 124 off of the actuator 122, thereby releasing the actuator 122.

In use, an operator pressurizes the system 105, as shown in step 10 of the method flowchart of FIG. 8c. The process continues with step 20, wherein the operator picks up the spray device 100. Step 30 provides for depressing the actuator 122 to commence the flow of the product through the spray device 100. Step 40 provides for applying the product to the predetermined area. In cases of large areas, the operator may be forced to walk through the predetermined application area while spraying. In step 45, the operator must determine if full coverage has been achieved. If product has not been applied to the entire predetermined area, the operator continues to apply the product to the untreated areas as described in step 40. If the product has been applied to the entire predetermined area, the operator moves to step 50, wherein the operator may release the actuator to cease the delivery of the product through the spray device 100.

In a second embodiment, a spray device 200 is identical to the spray device 100; however, the extension tube 110 of the spray device 100 is replaced with an extension tube 210. Accordingly, like parts have been annotated with like numerals. As shown in FIG. 7, a spray device 200 includes a valve assembly 120, an extension tube 210, a spray tip 115, and an inlet pipe 125. The extension tube 210 includes a first end 212, a second end 213, and a passage 214 therethrough. The extension tube 210 further includes a bend 211 near the second end 213, such that the direction of flow changes at an angle of approximately sixty degrees. The first end 212 further includes external threads, and the second end 213 includes external threads. The external threads are of a size and pitch complementary to an outlet 137 of the valve body 121, and the external threads are of a size and pitch complementary to the internal threads of the spray tip 115. Accordingly, the extension tube 210 may be configured to the outlet 137 of the valve body 121 in a manner consistent with the first embodiment.

On assembly, the extension tube 210 is secured to the outlet 137 and aligned with the bend 211 changing the direction of flow to a lowest position. Continued assembly provides for the slot 197 of the spray tip 115 being aligned with the plane of the bend 211 of the extension tube 210. In this arrangement, the valve assembly 120 may be mounted with the actuator 122 in a highest position, and the direction of the slot 197 of the spray tip 115 aligned with the plane of the bend 211 in the extension tube 210.

Operation of the valve assembly 120 and the spray device 200 is substantially identical to the operation of the spray device 100, however, the bend 211 in the extension tube 210 provides flexibility in the use of the spray device 100. With an increased length of the extension tube 210 and a shifted angle of attack due to the bend 211, an operator may effectively spray pressurized fluids closer to the ground.

Although the present invention has been described in terms of the foregoing preferred embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

I claim:

1. A spray device, comprising:
a valve assembly, including an inlet coupled with a fluid source and an outlet; and
a spray tip coupled to the outlet of the valve assembly, the spray tip comprising a housing including a passage in communication with a substantially vertically oriented slot, whereby a fluid is delivered through the passage of the spray tip to the vertically oriented slot, and exits spray tip in a wide vertical spray pattern.

2. The spray device according to claim 1, wherein the slotted end of the spray tip includes a taper.

3. The spray device according to claim 2, wherein the slot is aligned with the apex of the taper.

4. The spray device according to claim 3, wherein the slot extends beyond the taper.

5. The spray device according to claim 1, further comprising:
an extension tube coupled to the outlet and the spray tip, the extension tube including a passage in communication with the outlet, and the passage of the spray tip, whereby the fluid is delivered through the passage of the extension tube to the passage of the spray tip to exit the slot in a wide flat spray pattern at a prescribed distance from an operator.

6. The spray device according to claim 5, wherein the extension tube is in the range of twelve to twenty-four inches in length.

7. The spray device according to claim 5, wherein the extension tube includes a bend to allow the application of the fluid from a service vehicle.

8. The spray device according to claim 7, wherein the bend in the extension tube is approximately sixty degrees.

9. The spray device according to claim 1, wherein the spray device delivers a thrust force to counteract the weight of the spray device.

10. The spray device according to claim 1, wherein the fluid source is pressurized for delivery through the spray device.

11. The spray device according to claim 1, wherein the product source is secured to a service vehicle.

12. A spray tip, comprising:
a housing including a passage, and
a slot in communication with the passage, wherein a pressurized fluid is delivered to the passage, and further wherein, the pressurized fluid moves through the passage to exit the slot in a wide substantially vertical spray pattern.

13. The spray tip according to claim 12, wherein the second end includes a conical taper to extend the width of the spray pattern.

14. The spray tip according to claim 13, wherein the slot is located in alignment with an apex of the conical taper.

15. The spray tip according to claim 12, wherein the depth of the slot extends past the taper.

16. The spray tip according to claim 12, wherein the slot is oriented vertically to provide an even distribution of fluid along a vertical plane.

17. A method of delivering a wide spray pattern from a spray device, comprising:
a. actuating a valve assembly to permit a pressurized flow of a fluid from an inlet to an outlet, the outlet coupled to a spray tip including a passage communicating with a slot, wherein, the fluid passes into the passage in the spray tip to the slot, and further wherein, the slot is oriented substantially vertical; and
b. delivering the fluid through the substantially vertical slot, and onto desired vegetation in a wide vertical spray pattern.
